(19) United States
(12) Patent Application Publication
(10) Pub. No.: US 2014/0173906 A1
(43) Pub. Date: Jun. 26, 2014

(54) CABLE STRIPPING DEVICE

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: SONG MA, Shenzhen (CN); WU ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/846,922

(22) Filed: Mar. 18, 2013

(30) Foreign Application Priority Data
Dec. 26, 2012 (CN) 201210571639.6

(51) Int. Cl. H02G 1/12

(52) U.S. Cl. CPC H02G 1/1209
USPC 30/90.1

(57) ABSTRACT

A cable stripping device includes a main body, a slide block, and a motion member. The main body includes a top plate and a front plate. The front plate defines a first through slot. The slide block is located in the main body and slidable relative to the top plate. A slanting abutting wall is formed on the slide block. The motion member is located in the main body. The motion member defines a through hole. A slanting connection wall is formed on the motion member. A blade is attached to the motion member and located in the through hole. When a cable extends through the first through slot and the through hole below the blade, the slide block is slid forward, the abutting wall pushes the connection wall, the motion member moves down, thereby allowing the blade to cut the cable.

### BACKGROUND

1. Technical Field

The present disclosure relates to a device for stripping insulation layers from cables.

2. Description of Related Art

When a plurality of bared cables is needed in industrial production, an operator operates a cable stripper to strip the insulation layers from the cables. The cable stripper cuts on opposite sides of each cable, which means opposite sides of each cable bear force. If the operator accidentally brings too much force to the cable, the cable may be sheared off.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of a cable stripping device.

FIG. 2 is similar to FIG. 1, and viewed from a different perspective.

FIG. 3 is an assembled, isometric view of FIG. 1.

FIG. 4 is a cross-sectional view taken along the line IV-IV of FIG. 3.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

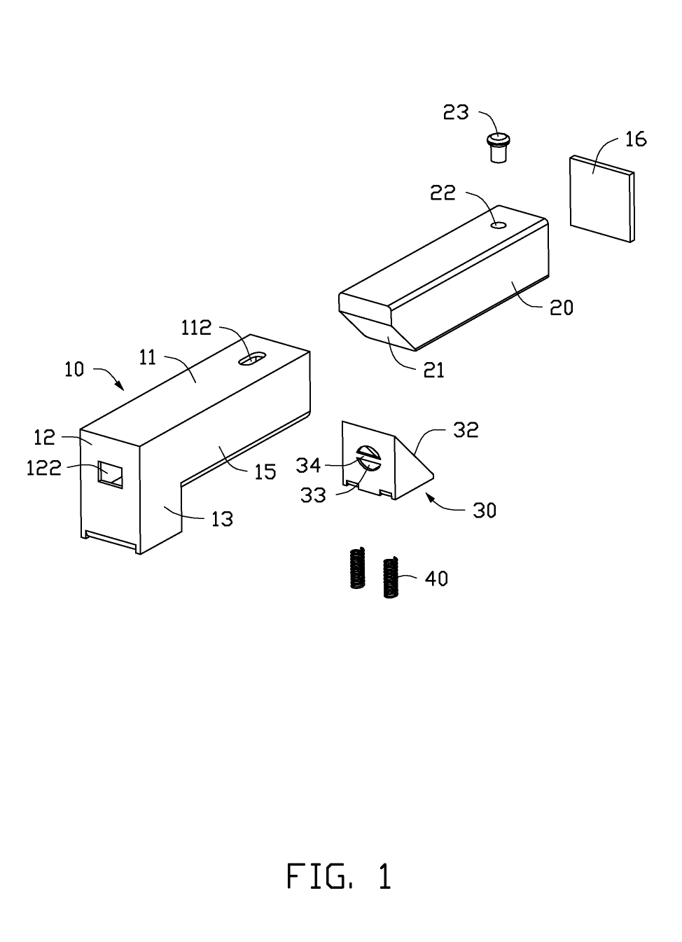

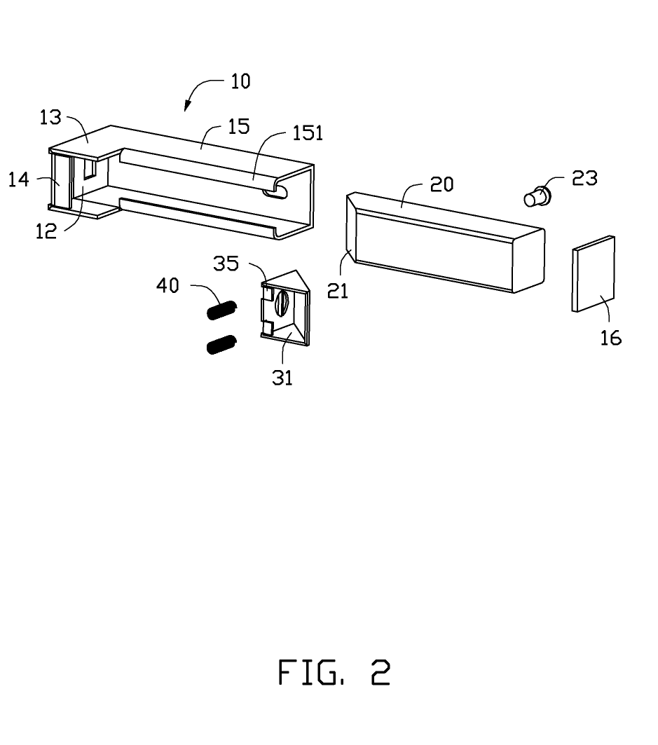

FIGS. 1 and 2 show an exemplary embodiment of a cable stripping device. The cable stripping device includes a main body 10, a slide block 20, a motion member 30, and two resilient members 40. In the embodiment, the resilient members 40 are two springs.

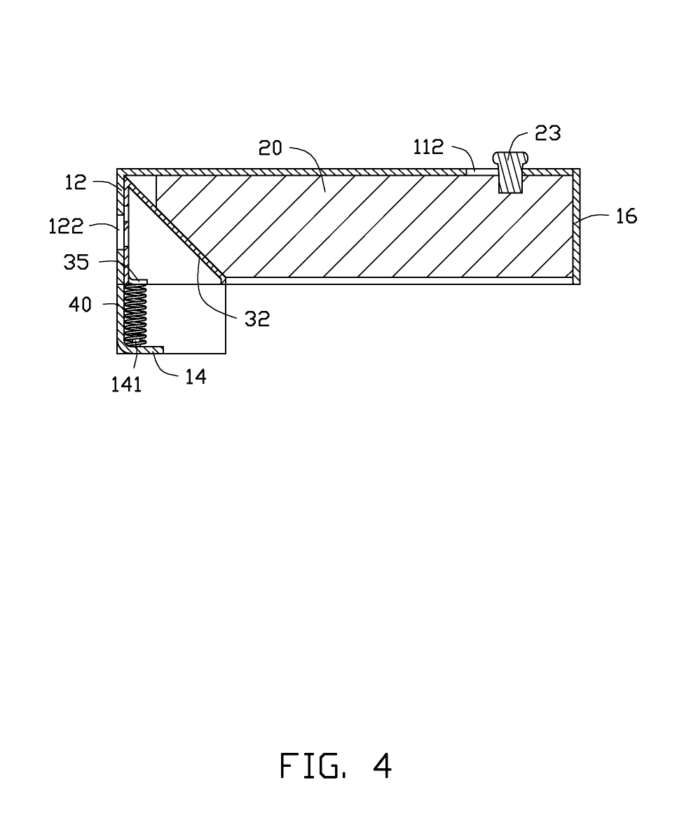

The main body 10 includes a top plate 11, a front plate 12 perpendicularly extending down from a front end of the top plate 11, two connection plates 13 perpendicularly extending back from opposite sides of the front plate 12, a bottom plate 14 extending back from a bottom end of the front plate 12, two side plates 15 extending down from opposite sides of the top plate 11 and connected to rear sides of upper portions of the connection plates 13, and a cover plate 16. A through slot 112 is longitudinally defined in a rear portion of the top plate 11. A through slot 122 is defined in the front plate 12. Two protrusions 141 protrude up from the bottom plate 14 (shown in FIG. 4). Two slide plates 151 extend from bottom sides of the side plates 15, extending toward each other.

An abutting wall 21 slantingly extending toward the back and down is formed on a front end of the slide block 20. A mounting hole 22 is defined in a rear portion of a top surface of the slide block 20.

The motion member 30 is substantially wedge-shaped. The motion member 30 is hollow and defines an opening 31 in a bottom of the motion member 30. A connection wall 32 slantingly extending back and down is formed on a rear side of the motion member 30. A through hole 33 is defined in a front side of the motion member 30. A blade 34 is attached to the motion member 30 and located at a middle of the through hole 33. Two extension tabs 35 extend back from a bottom of the front side of the motion member 30.

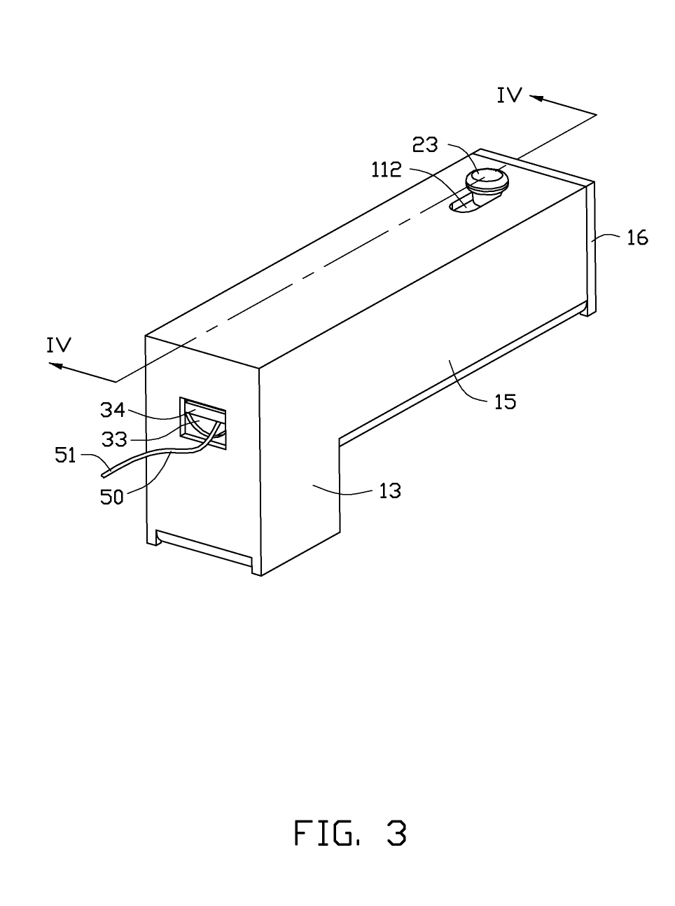

FIGS. 3 and 4 show in assembly. The resilient members 40 are placed around the protrusions 141. The height of the resilient members 40 is greater than the height of the protrusions 141. The motion member 30 is placed between the side plates 15 and supported on the slide plates 151. The motion member 30 is slid along the slide plates 151, until the front side of the motion member 30 abuts against an inner side of the front plate 12. The extension tabs 35 abut against top ends of the resilient members 40. The blade 34 aligns with the through slot 122. The slide block 20 is placed between the side plates 15, supported on the slide plates 151 and abutting against an inner side of the top plate 11. The slide block 20 slides along the slide plates 151 and the top plate 11. The abutting wall 21 abuts against the connection wall 32. A fastener 23 extends through a rear end of the through slot 112 and engages in the mounting hole 22. The cover plate 16 is fastened on rear ends of the top plate 11 and the side plates 15.

In use, a cable 50 extends through the through slot 122 and a lower portion of the through hole 33 below the blade 34. The fastener 23 is manipulated forward along the through slot 112. The abutting wall 21 pushes the connection wall 32. The motion member 30 moves down and the slide block 20 moves forward. The resilient members 40 are deformed. The blade 34 moves down and cuts an insulation layer 51 of the cable 50. The cable 50 is rotated, thus, the insulation layer 51 located in the cable stripping device is stripped off from the cable 50. The fastener 23 is released, the resilient members 40 is restored, to bias the motion member 30 and the slide block 20 to return back. The blade 34 only cuts on one side of the cable 50, the force brought to the cable 50 can be precisely controlled.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A cable stripping device, comprising:
a main body comprising a top plate and a front plate extending down from a front end of the front plate, the front plate defining a first through slot;
a slide block located in the main body and slidable relative to the top plate, a slanting abutting wall formed on a front end of the slide block; and
a motion member located in the main body and slidable relative to the front plate, the motion member defining a through hole, a slanting connection wall formed on a rear side of the motion member, a blade attached to the motion member, located in the through hole and aligning with the first through slot;
wherein when a cable extends through the first through slot and the through hole below the blade, the slide block is manipulated to slide forward, the abutting wall of the slide block pushes the connection wall of the motion member, the motion member moves down, thereby allowing the blade to cut an insulation layer of the cable.

2. The cable stripping device of claim 1, wherein a second through slot is longitudinally defined in the top plate, a fastener extends through the second through slot and engages in the slide block.

3. The cable stripping device of claim 1, further comprising a resilient member to bias the motion member and the slide block to slide back.

4. The cable stripping device of claim 3, wherein a bottom plate extends back from a bottom of the front plate, opposite ends of the resilient member abut against the bottom plate and a bottom of the motion member.

5. The cable stripping device of claim 4, wherein a protrusion protrudes up from the bottom plate, the resilient member is placed around the protrusion.

6. The cable stripping device of claim 1, wherein the motion member is hollow, an opening is defined in a bottom of the motion member.

7. The cable stripping device of claim 1, wherein the main body further comprises two side plates located at opposite sides of the top plate, two slide plates extend from bottom sides of the side plates and extend toward each other, the slide block is supported on and slid along the slide plates.

8. The cable stripping device of claim 7, wherein a cover plate is fastened on rear ends of the top plate and the side plates.
